(19) United States
(12) Patent Application Publication
(10) Pub. No.: US 2024/0289245 A1
(43) Pub. Date: Aug. 29, 2024

(54) ADDRESSING LOSS OF PERFORMANCE IN THE PREDICTION OF THE NEXT BEST COMPRESSOR IN A STREAM DATA PLATFORM

(71) Applicant: Dell Products L.P., Round Rock, TX (US)

(72) Inventors: Rômulo Teixeira de Abreu Pinho, Niterói (BR); Vinicius Michel Gottin, Rio de Janeiro (BR); Joel Christner, El Dorado Hills, CA (US); Raul Gracia, Barcelona (ES)

(21) Appl. No.: 18/176,057

(22) Filed: Feb. 28, 2023

(51) Int. Cl. G06F 11/34; G06F 16/2455

(52) U.S. Cl. CPC G06F 11/3409; G06F 16/24568

(57) ABSTRACT

Detecting a decrease or loss in performance of a prediction engine configured to predict a compressor for compressing data. The prediction engine suffers a loss in performance when the compressor inferred by the prediction engine does not match or does not sufficiently match a compressor inferred by a compressor selector. Using compressors inferred by two different models allows the loss in performance to be detected. The loss in performance may constitute a violation of a service level agreement (SLA) or service level objective (SLO). Then the loss in performance is determined.

### FIELD OF THE INVENTION

Embodiments of the present invention generally relate to data compression. More particularly, at least some embodiments of the invention relate to systems, hardware, software, computer-readable media, and methods, for predicting a data compressor for compressing data and addressing a loss of performance in predicting the data compressor.

### BACKGROUND

Data compression is widely used in data movement, data transmission, and data storage scenarios to improve bandwidth usage and save storage capacity. Streams are a type of data that may benefit from compression because of the likelihood of pattern repetitions and predictability over time. Indeed, stream processing platforms and message queueing (pub/sub) frameworks allow the use of compression at different levels. Some platforms include compression at the client/publisher side only to save on bandwidth. Other platforms, which also handle stream/message archives, may include compression for saving on storage capacity. Dell currently offers the Stream Data Platform (SDP) as a solution to manage stream workloads through the Pravega stream management framework. However, neither the SDP nor Pravega currently offer data compression. Moreover, running a compression optimization engine for each stream batch may be costly, especially at the client side, where near real time stream management requires high computational performance.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an architecture and a method to estimate compressor performance metrics of all compressors in a set from the execution of a single reference compressor on a chunk of the file to be compressed;

FIG. 2 discloses an example of client-side, content and context-aware stream compression;

FIG. 3 discloses an example of server-side, content and context-aware stream compression for data movement across storage tiers;

FIG. 4 discloses an example of a high-level architecture to build a training dataset to learn relationships between stream patterns and selected compressors under various SLA constraints;

FIG. 5 discloses an example of the embedding of a stream batch into a vectorial representation of dimension d;

FIG. 6 discloses an example of an iterative training process for learning the function y=ƒ(X|θ);

FIG. 7 discloses aspects of the structure and operation of an example prediction engine;

FIG. 8 discloses an example method for predictive and adaptive data compression;

FIG. 9A discloses aspects of detecting a loss in performance using a prediction engine and a compressor selector;

FIG. 9B discloses aspects of detecting a loss or decrease in performance based on compressors inferred by the prediction engine and the compressor selector;

FIG. 9C discloses aspects of generating compression metrics to detect a loss or decrease in performance using a soft mode;

FIG. 9D discloses aspects of using a ratio of SLA violations to detect a loss or decrease in performance;

FIG. 9E discloses aspects of a method for detecting and remedying a loss or decrease in performance of a prediction model and/or a compressor detector; and

FIG. 10 discloses aspects of an example computing entity operable to perform any of the disclosed methods, processes, and operations.

### DETAILED DESCRIPTION OF SOME EXAMPLE EMBODIMENTS

Embodiments of the present invention generally relate to data compression. More particularly, at least some embodiments of the invention relate to systems, hardware, software, computer-readable media, and methods, for selecting an optimal data compressor and using the selected data compressor to compress a group of data. More particularly, embodiments of the invention relate to handling performance issues or drift in machine models configured to predict a compressor for compressing a group of data, such as a data stream or portion thereof.

In general, an embodiment of the invention may comprise a training and inferencing architecture that may enable relatively fast prediction of a compressor for a next portion of a stream. The next portion of a stream to be compressed may be referred to as a stream batch. The process of predicting the compressor to compress the next stream batch may include (1) extracting patterns from stream batches, (2) associating the patterns with selected compressors and corresponding SLA (Service Level Agreement) or SLO (Service Level Objective), and/or other, constraints, (3) building a prediction engine to infer the best compressor for a next, or subsequent, portion of a data stream, and (4) embedding the engine in a stream data platform. The selected or predicted compressor may then be used to compress a grouping of data such as a stream batch. As used herein, a ‘best’ compressor embraces, but is not limited to, a compressor that is selected at least in part based on historical data patterns in a stream, and then used to compress a grouping of stream data that is created and/or transmitted/received later in time than the historical data patterns upon which the compressor selection was based.

In particular, one advantageous aspect of an embodiment of the invention is that a data compressor, which may be optimal in view of various constraints and/or parameters, may be selected on-the-fly, that is, in real time, while a data stream, which includes the data to be compressed, is being received or transmitted. Thus, one or more example embodiments may identify, and employ, an optimal data compressor.

An embodiment may use historical information, including data stream patterns for example, to predict an optimal data compressor for a grouping of data in the data stream from which the historical information was obtained. An embodiment may automatically adapt to changes in a data stream by selecting a data compressor that may provide better compression performance, relative to a data compressor that may have been in-use prior to, and/or at, a time when the changes occurred. An embodiment may implement both adaptive, and predictive, data compression with respect to data in a data stream. An embodiment may predict, such as based on historical information, a particular data compressor expected to be needed for compression of a portion of a data stream and may then adapt to a change in the data stream by putting the predicted compressor into operation for at least the portion of the data stream. Various other advantages of one or more embodiments will be apparent from this disclosure.

Embodiments of the invention further relate to detecting a loss of or decrease in a performance in the prediction engine, which may include a machine learning model such as a prediction model. Reference herein to the prediction engine may specifically apply to the prediction model. For example, the compressor predicted by the prediction engine may be inferred or predicted by the prediction model. Detecting the loss in performance may also use a compressor selector, which is an example of a machine learning model that is configured to predict or infer an optimal compressor in different circumstances as discussed in more detail herein.

The loss of performance may relate to data drift, concept drift, or the like. Embodiments of the invention relate to detecting the loss in performance and to retraining the prediction model and/or the compressor selector (the models) accordingly. In one example, the loss in performance or drift may result in SLA violations. Embodiments of the invention further relate to detecting SLA violations or potential SLA violations and to updating the models to remedy the SLA violations and/or the drift in the models.

Streaming and messaging frameworks such as RabbitMQ, Kafka, IBM-MQ, and Apache Pulsar enable data compression. In such frameworks however, compression starts at the client side and can only be statically switched on or off via the framework configuration files. In addition, such frameworks typically support only a handful of pre-configured compression algorithms that apply to a message channel or to the whole framework once compression is switched on. IBM-MQ goes a step further by allowing sender and receiver ends of a communication channel to negotiate on a compression algorithm that they both support. The agreed-upon compression algorithm is selected from a list of pre-existing compression algorithms. By way of contrast, an embodiment of the invention may comprise, among other things, both content and context-aware compression for stream data platforms.

For example, one embodiment of the invention may leverage optimization procedures for compression selection, examples of which are disclosed herein in: [1] U.S. Pat. No. 11,394,397, titled “SYSTEM AND METHOD FOR SELECTING A LOSSLESS COMPRESSION ALGORITHM FOR A DATA OBJECT BASED ON PERFORMANCE OBJECTIVES AND PERFORMANCE METRICS OF A SET OF COMPRESSION ALGORITHMS”, issued 19 Jul. 2022; [2] U.S. patent application Ser. No. 17/199,914, titled “PROBABILISTIC MODEL FOR FILE-SPECIFIC COMPRESSION SELECTION UNDER SLA-CONSTRAINTS”, filed 12 Mar. 2021; and [3] U.S. patent application Ser. No. 17/305,112, titled “PROBABILISTIC MODEL FOR FILE-SPECIFIC COMPRESSION SELECTION UNDER SLA-CONSTRAINTS”, filed 30 Jun. 2021 (collectively, the “Compression Selection Applications”). The Compression Selection Applications are incorporated herein in their respective entireties by this reference.

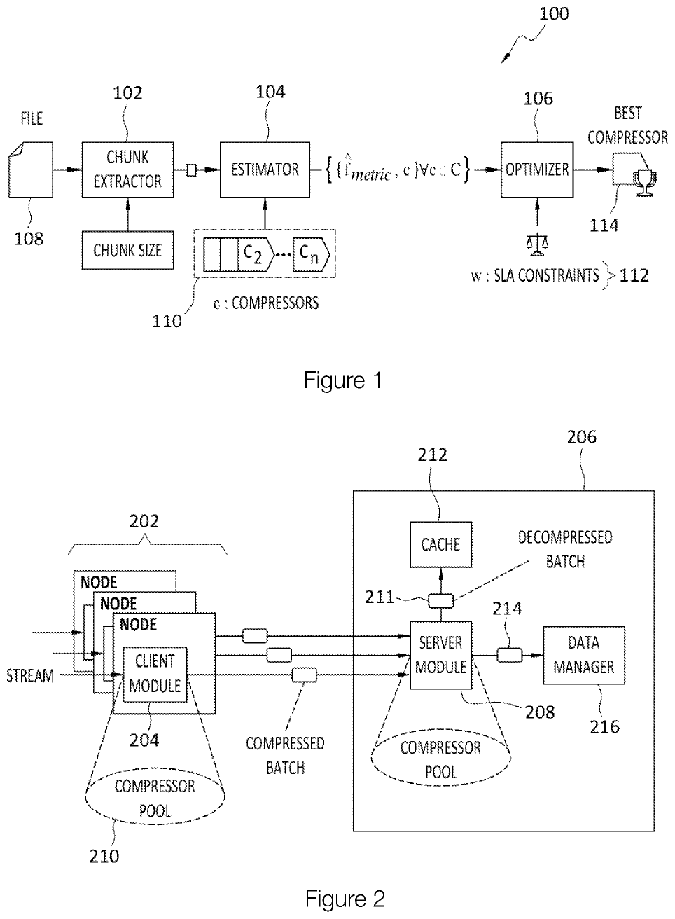

With reference now to FIG. 1, and as set forth in one or more of the Compression Selection Applications, there is disclosed an architecture, or pipeline, 100 in which a method may be implemented for estimating compressor performance metrics of all compressors in a set, based on the execution of a single reference compressor on a chunk of the file to be compressed. In general, and as indicated in FIG. 1, a compression algorithm or a compressor may be selected for some data out of a pool of candidate compressors, using only a small section of the data as input for the selection and a reference compressor. The selection may satisfy the application-dependent SLA constraints provided as arguments, which may optimize for storage savings, speed of compression and/or decompression, cost of computation, overall time for data compression plus transmission plus decompression, or any combination thereof.

In more detail, the example configuration of FIG. 1 comprises a pipeline 100 that may include a chunk extractor 102 configured to communicate with an estimator 104 which, in turn, is configured to communicate with an optimizer 106. In general, and as shown, the pipeline 100 may operate in connection with static data 108, that is, data that is not being streamed, such as one or more files for example. In the example of FIG. 1, a compression algorithm may be selected, for use with the data 108, out of a pool 110 of candidate compressors, using only a small section, such as a chunk for example, extracted from the data 108 by the chunk extractor 102, as input for the selection of a reference compressor. The selection may satisfy application-dependent SLA constraints 112 which may be provided as arguments to the optimizer 106, which may optimize for storage savings, speed of compression and/or decompression, cost of computation, overall time for data compression plus transmission plus decompression, or any combination thereof. An output of the optimizer 106 may be a selection of the ‘best’ compressor 114 to use for the data 108, given the constraints 112. Further details concerning the configuration and operation of the example pipeline 100 are disclosed in the Compression Selection Applications.

In one example, various components of the pipeline 100 are included in or represent a machine learning model, referred to as a compressor selector herein, that is configured to select or infer a compressor for compressing data as set forth in the Compression Selection Applications.

An embodiment of the invention may assume the existence of a compression selection service for streams as part of a streaming data platform. Examples of client and server-side modules for this type of service are disclosed in: [1] U.S. patent application Ser. No. 18/047,486, titled “COMPRESSION ON-DEMAND IN A STREAM DATA PLATFORM”, filed 18 Oct. 2022; and [2] U.S. patent application Ser. No. 18/062,197, titled “MULTI-OBJECTIVE COMPRESSION FOR DATA TIERING IN A STREAM DATA PLATFORM”, filed 6 Dec. 2022 (2022); and [3] U.S. patent application Ser. No. 18/157,566, titled “PREDICTING THE NEXT BEST COMPRESSOR IN A STREAM DATA PLATFORM”, FILED Jan. 20, 2023, (collectively, the “Module Applications”). The Module Applications are incorporated herein in their respective entireties by this reference.

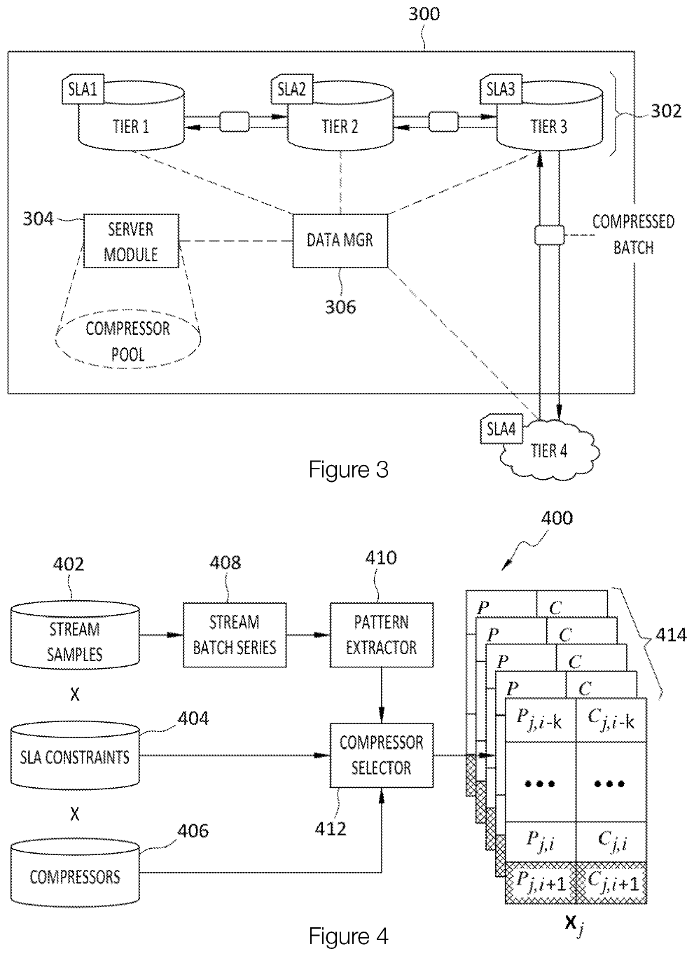

As shown in FIG. 2, at a client side 202, a client module 204 (or client) may determine whether a stream is compressible and requests a content and context-aware compression service from a stream platform 206 server module 208. The service may be deployed at the client side 202 and may enable the client side 202 to carry out compression selection, such as selecting a compressor from a pool 210 of compressors, that is suited for the characteristics of the stream and that also satisfies SLA constraints for the client. The selected compressor is the compressor inferred by the compressor selector. The client module 204, via the compression service, may compress stream batches using the selected compressor and pack them with compression-related metadata before sending them to the server module 208. The server module 208, in turn, may receive the batches and decompress those with the compressor indicated in the packet metadata, which may also reside in the compressor pool 210. The server module 208 may place uncompressed data 211 into a system cache 212, to be consumed by applications, and may forward the compressed batch 214 to a data manager 216 within the stream platform 206, for further processing.

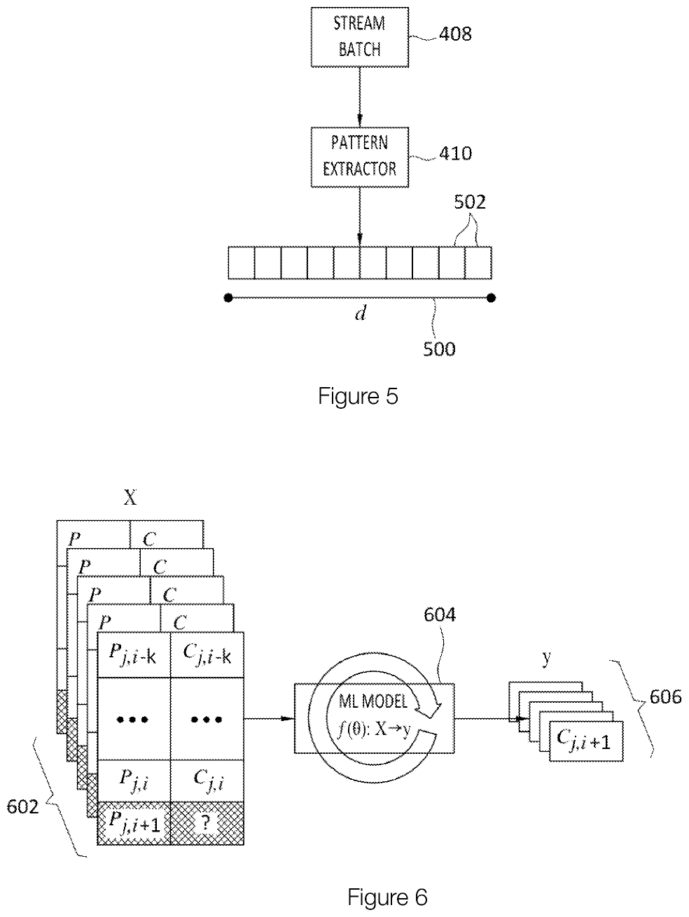

At the server side, and with reference now to FIG. 3, which discloses server-side, content and context-aware stream compression for data movement across storage tiers, content and context-aware compression may be used to move, such as in a stream data platform 300, data efficiently across storage tiers 302. The stream data platform 300 may comprise a server module 304 with a compression selection service. A data manager 306 within the stream data platform 300 may be responsible for moving data across tiers 302. Each of the tiers 302 may be configured, via the server module 304, with compression SLA objectives. When the data manager 306 decides to move data across tiers, the data manager 306 may invoke the compression service within the server module 304 to decompress stream batches, which may be packed, as disclosed in the Compression Selection Applications, from the source tier, which may be any of the tiers 302, and to recompress the stream batches using the SLA objectives of the target tier, which may be another of the tiers 302. By doing this, each batch may be compressed with a different compressor, possibly within the same tier, as long as the SLA objectives of the target tier 302 are met.

An embodiment of the invention may be implemented in stream and message processing platforms, such as the Dell SDP for example, where lossless data compression may be beneficial. One embodiment may assume a stream processing architecture comprising client modules (see FIG. 2), which may collect the stream data and send the data to the server through a communication channel, and a server module (see FIG. 3) that may handle aggregation, management, and storage. An embodiment may further assume the presence of a content and context-aware engine that is able to select the best compression algorithm for a stream batch, as disclosed in the Compression Selection Applications and/or the Module Applications.

One or more embodiments of the invention may relate to a method, an architecture, and a protocol to enable the prediction of the best compressor for an expected stream batch at different stages of a stream data management process.

In one example, a training module may operate to learn the correlation between stream batch patterns and selected compression algorithms. Training may be performed off-line and may include: (1) building a training data set that may associate stream data patterns with compression algorithms; and (2) training a machine learning model—which may be referred to as a trained prediction model (or prediction model)—that may operate to infer the best compressor given a window of past stream patterns and compressors selected to satisfy given SLAs. The trained prediction model may be embedded together with the stream data platform, both at the server, and at the connected clients.

An inference module, an example of which is a prediction engine or which may include a prediction engine, may be embedded in the clients with the trained prediction model. Note that the prediction model is the resultant, or result/output, of the training module. That is, the training module may operate to generate, using training input, the prediction model. During the first k stream batches collected by the client, the standard compression selection may be executed as disclosed in one or more of the Compression Selection Applications. Concomitantly, features may be extracted from the batches of data and stored alongside the selected compressors. From the k+1 batch onward, the trained prediction model may be used to infer the compressor for a batch of data, taking as input, the window of k batch features and respective associated compressors. The inferred compressor may be executed on the batch of data and the compressed data may then be sent to the server. Note that any batch k+n may be evaluated for inferencing, where ‘n’ is any integer equal to or greater than 1.

An inference module may be embedded in the server, and may include the prediction model. The inference module may use the prediction model to draw inferences as to which data compressor should be used for a given batch of data, such as a stream batch. The functionality on the server side may be the same as, or similar to, that on the client side, except that the compressor prediction is applied when data is moved across tiers within the stream data platform.

Thus, example embodiments may possess various useful features and aspects. For example, an embodiment may generate or infer the next best compressor for a stream batch. Particularly, by leveraging knowledge about stream patterns and historical information about the best compressor for each stream batch, an embodiment may operate to predict the next best compressor for a stream or a stream batch with reasonable confidence. Note that as used herein, a ‘next best’ compressor is made in reference, for example, to a data stream that includes a first portion, and a second portion that follows later in time after the first portion. The first portion may be compressed with a first compressor, and the next, or second, portion may be compressed with a next best, or second, compressor that is best suited, as among a group of compressors, for compressing the second portion.

As another example, an embodiment of the invention may comprise a stream data platform with both adaptive, and predictable, compression. As noted, an embodiment may operate to predict, such as based on historical information, a particular data compressor expected to be needed for compression of a next, or subsequent, portion of a data stream, and may then adapt to a change in the data stream by putting the predicted compressor into operation for at least the portion of the data stream.

Selecting the best compressor for some data, considering data patterns and SLA objectives for example, can be computationally costly, especially at the client side, where near real time stream management requires high computational performance. In the Compression Selection Applications, for instance, the selection of the best compressor, in one embodiment, may rely on executing at least one reference compressor on a chunk of the data to estimate compression metrics of other compressors in the pool of compressors. Consequently, it may be desirable to make the data compressor selection process more efficient.

An embodiment of the invention may achieve higher efficiency in compression by exploiting possibly hidden, recurrent, patterns of stream data. Such patterns may be exploited by the compression algorithms themselves. However, an embodiment of the invention may operate to leverage the recurrence to predict the best compressor, for a next stream batch, in a lightweight manner.

One such pattern of stream data is that the difference between subsequent stream samples, that is data samples from the same data stream, tends to be small. This is true, for instance, in sequences of telemetry data points, sequences of video frames or audio packets, or even in JSON (JavaScript Object Notation) messages where the metadata across samples is almost equal or similar. From there, and given constant SLA objectives, a compression/compressor selected for a batch of stream data may be expected to be very similar to, or even the same as, the compression/compressor selected for the subsequent, or ‘next,’ batch of stream data. The next batch of stream data may be from the same data stream as one or more batches that temporally precede that next batch.

In addition, the presumably, in some cases at least, low temporal variance of stream data may have some predictable patterns, much like in a time series. Not only may such predictability be leveraged to infer what a stream will, or may, look like after a few batches, but this approach may also enable the prediction of which compressor may be selected for a batch if it is known which compressors were used in one or more previous, temporally, batches. As will be apparent from this disclosure, a stream or data stream may be considered as comprising, or consisting of, multiple batches of data.

An embodiment of the invention may operate to build a training dataset from which it may be possible to learn relationships between stream patterns and the compressors selected for a batch under SLA, and/or other, constraint(s). Such a training dataset may be built by collecting stream samples of various types and compressing those samples with the compression selection method of the Compression Selection Applications under various SLA constraints. In addition, stream samples may be arranged in a series of batches, and a stream pattern extraction module may be required to extract patterns of interest from those batches.

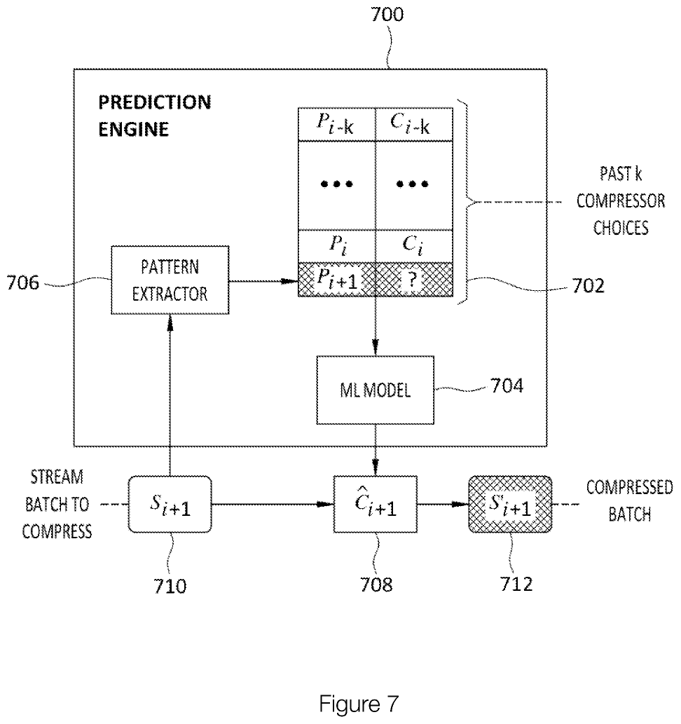

An example high-level architecture for a dataset building stage is disclosed in FIG. 4. Particularly, FIG. 4 discloses an example architecture 400 which may be used to build a training dataset to learn relationships between stream patterns and selected compressors under various SLA constraints.

Initially, a database 402 with stream samples may be obtained from real and/or synthetic stream data of various formats. Such formats may include, but are not limited to, telemetry of various kinds, video frames, audio packets, and text messages. Next, a set of SLA constraints 404 may be generated by varying all available SLA constraint parameters within acceptable ranges. As noted in the Compression Selection Applications, such SLA constraint parameters may comprise any of a compression ratio, compression/decompression speed, CPU usage, memory usage, and any grouping of one or more of these. Finally, a pool 406 of lossless compressors may be assembled that includes all compressors that will be supported in one or more embodiments.

In an embodiment, the stream samples may first be converted into a series 408 of k subsequent stream batches, where k may be a hyper-parameter of an embodiment of the invention. Note that as used herein, a ‘sample’ is a subset of a ‘batch.’ Next, patterns of interest for the training procedure may be extracted, such as by a pattern extractor module 410, from each batch in the series. Patterns of interest may vary according to the stream type. In video streams, for example, patterns that are related to compression may include frequency components within 8×8 image blocks, signal to noise (SN) ratio, first and second-order image derivatives, and entropy of color channels.

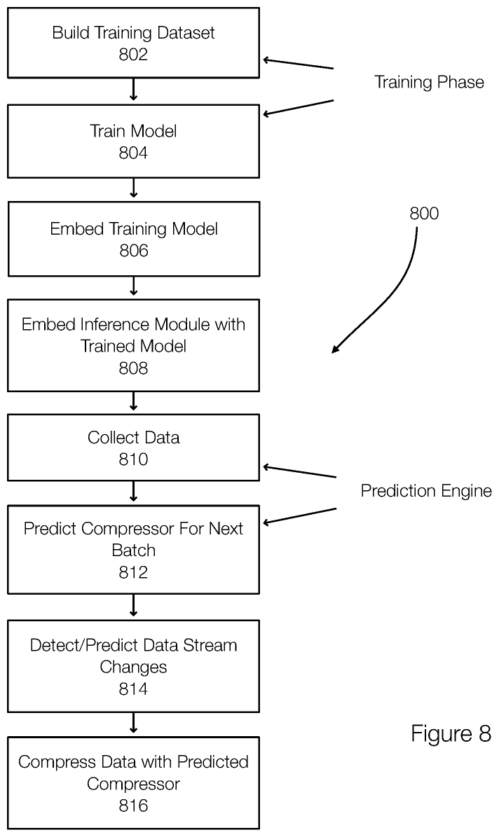

Irrespective of the stream type and set of patterns to be extracted, the pattern extractor module 410 may yield, as disclosed in FIG. 5, a vector 500 of real stream values 502, where the vector 500 may have a pre-defined dimension d, which may be another hyper-parameter of an embodiment of the invention. That is, FIG. 5 discloses the embedding of a stream batch into a vectorial representation of dimension d.

In an embodiment, the pattern extractor module 410 may be implemented using an approach in machine learning sometimes referred to as ‘embedding.’ In general, embedding mechanisms may transform data from its raw format, such as text, video, or audio, for example, into a numerical, vectorial representation, such as the vector 500, that is amenable to learning algorithms. Each embedded vector 500 may thus represent a pattern P_{j,i} as disclosed in FIG. 4.

In the next operation, in one embodiment, the best compressor for each stream batch may be selected using a method disclosed in the Compression Selection Applications, and implemented by a compressor selector module 412. Each data pattern P_{j,i} associated with a batch may be matched with a compressor C_{j,i} selected for the batch. A sequence xⱼ 414 of k subsequent {C_{j,i}, P_{j,i}} pairs may be assembled and stored in a training data base.

As noted elsewhere herein, the trained prediction model is the resultant, or result/output, of the training module. That is, the training module may operate to generate, using training input, the trained prediction model. The trained prediction model, which may comprise a machine learning (ML) model, trained by the training module, to perform an inferencing function regarding a next best compressor, may then be sent to the inference module for use by the inference model in generating an inference as to which compressor should be used for a batch or sample of stream data. Following is a more detailed discussion of the training of the prediction model.

Machine learning may generally aim to fit a function y=ƒ(X|θ) with parameters θ to some data (X, y), where X represents the set of independent (or predictor, or input) variables and y represents the set of dependent (or target, or output) variables. Supervised training (or fitting) is an iterative process by which ƒ(X|θ) generates estimates ŷ of y until the difference between the two is sufficiently small. During this process, the parameters θ may be corrected relative to difference between ŷ and y, until an optimal set of parameters, θ*, is obtained.

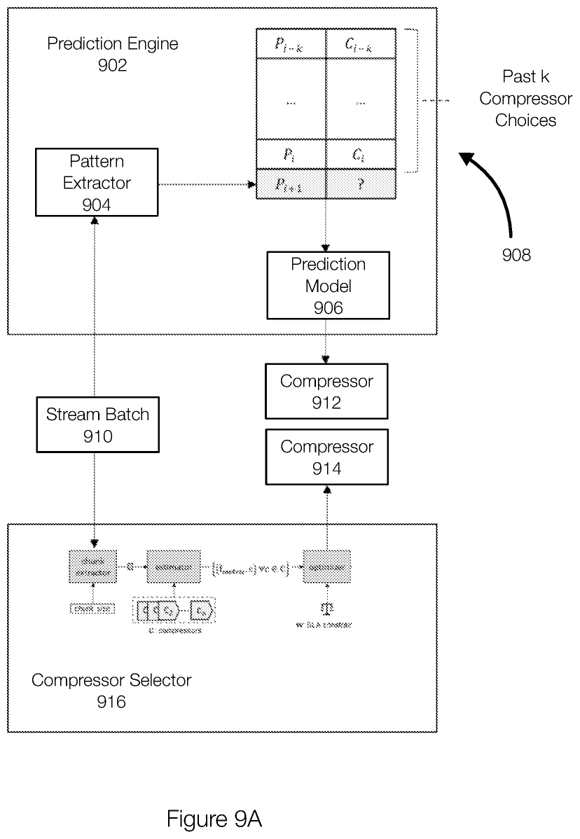

As shown in FIG. 6, which discloses an example of an iterative training process to learn the function y=ƒ(X|θ), each input sample xⱼ 602, to a prediction model 604 that may comprise a machine learning (ML) model, may be a sequence of k pairs (P_{j,i}, Cᵢ) indicating the compressor Cᵢ that has been selected for a particular stream batch pattern P_{j,i}. In general, the prediction model 604 may receive, as input, the input samples xⱼ 602, and the prediction model 604 may then use the function ƒ(θ) to generate a respective compressor prediction y 606 for each of the input samples xⱼ 602.

In an embodiment, the input samples xⱼ 602 may also each contain an entry representing a pattern P_{j,i+1}, which is the pattern whose compressor is to be predicted by the prediction model 604. From the training dataset, an embodiment may know, or determine, that a compressor C_{j,i+1} was chosen, and that compressor may be used as the target variable yⱼ, corresponding to input xⱼ. In an embodiment, this process may be repeated for each (xⱼ, yⱼ) and the prediction model 604 trained iteratively.

Note that C_{j,i+1} may be a categorical value that may be associated with an index of a compressor in the pool. A practice in machine learning is to represent the categorical value with a vector whose dimension matches the number of compressors in the pool. The position of the vector that corresponds to the compressor index is then set to 1 and all others are set to zero. This process is sometimes referred to as one-hot-encoding, and, in an embodiment, it may indicate a probability that compressor C_{j,i+1} is the one selected for input xⱼ. Training of the prediction model 604 may thus entail minimizing the error in predicting the most probable compressor for some input stream batch series such as, for example, a cross-entropy loss function.

The trained prediction model 604 may then be embedded, for the performance of inferencing processes, into a stream data platform, both at the server and at the connected clients. The inference module that includes the trained prediction model 604 may then have the task of predicting the next compressor for some stream batch, where the prediction may be based on the selected compressors for a series of past batches.

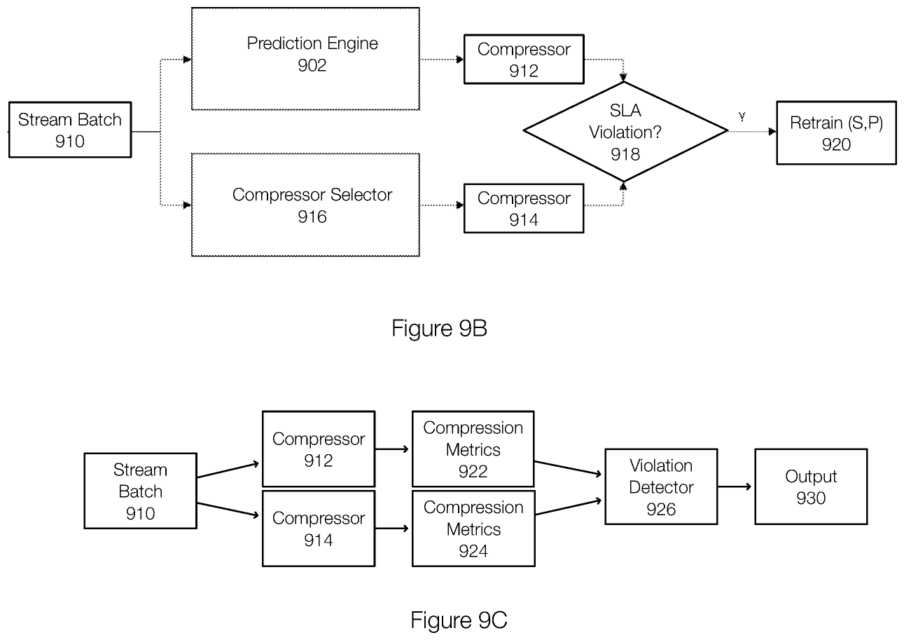

Reference is made now to FIG. 7, which discloses a prediction engine 700, which may comprise, or consist of, a trained prediction model. FIG. 7 also discloses some example operations for predicting a next best compressor within an inference module that may include the prediction engine 700.

An embodiment may assume that, when the inference module or prediction engine is deployed, there may be no history 702 of stream batches and associated compressors available. For this reason, the inference module may either start, or continue, to execute compression selection, as disclosed elsewhere herein. Given, for example, a lag of k batches, the inference module may run the traditional compression selection for k steps and collect pairs of batch patterns and selected compressors, {Pᵢ, Cᵢ}.

The inference module may then begin to predict, using the trained prediction model 704, the best compressor from the k+1 batch onward. For each new batch, the inference module may assemble a series of k pairs of {Pᵢ, Cᵢ} and extract, using a pattern extractor 706, the patterns Pᵢ₊₁ for the k+1 stream batch Sᵢ₊₁. The inference module may then feed this sequence of data to the prediction model 704 to obtain a prediction 708 of the compressor (Ĉᵢ₊₁) for pattern Pᵢ₊₁, Cᵢ₊₁. The predicted compressor may then be used to generate, from the data 710 Sᵢ₊₁, the compressed version 712 S′ᵢ₊₁ of the data 710 Sᵢ₊₁. After obtaining the predicted compressor from the trained prediction model 704, the inference module may discard the {Pᵢ₋ₖ, Cᵢ₋ₖ} pair of the latest stream batch series and create another pair {Pᵢ₊₁, Cᵢ₊₁}, which may then integrate the series to predict the best compressor for the next incoming stream batch.

As will be apparent then, an embodiment of the invention may comprise a predictive mechanism, and an adaptive mechanism, which may be applied to stream management throughout a data processing pipeline. Both client-side and server-side compression, respectively, may benefit from dynamic and intelligent selection of compressors based on stream content and application SLA constraints across all storage tiers. Such adaptivity may lead the selected compressor to be different for each stream batch.

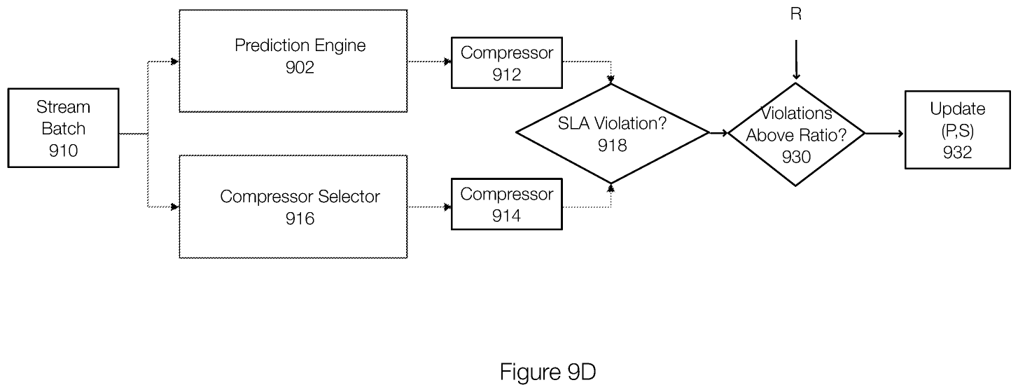

FIG. 8 relates to a method 800 for predicting a compressor for compressing data of predicted data. Part, or all, of the method 800 may be performed in a client-server environment, on the client side and/or on the server side of a stream data platform. In an embodiment, a training phase of the method 800 may be performed at the same site(s) where the other elements of the method 800 are performed. In an embodiment, a training phase of the method 800 may be performed at a different site from the site where the other elements of the method 800 are performed.

The example method 800 may begin with the building 802 of a training dataset that may be used to train 804 a compressor prediction model, or prediction model, that may comprise an ML model. The operations 802 and 804 may collectively define a part of an example training phase according to one embodiment. In an embodiment, the operations 802 and 804 may be performed by a training module. In an embodiment, the prediction model may exist as a basic generic ML model prior to being trained in the training operation 804. The training module may, or may not, create the basic generic ML model.

After the prediction model has been generated and trained 804, respective instances of the prediction model may be embedded 806 at a client-side site and/or at a server-side site.

After the inference module and prediction model have been put in place at one or more sites (client and/or server sides), the prediction engine may begin to collect data 810 from a data stream that is being received from, or transmitted to, another entity. In an embodiment, the data stream may comprise any number of batches, from each of which one or more samples may be taken. The collected data may be analyzed, and any patterns and/or historical information in, and/or implied by, the collected data may be used as a basis to generate a prediction 812 as to which data compressor should be used for a subsequent batch of data in the data stream from which the collected data was obtained. A subsequent batch of data may comprise, for example, the next batch of data, that is, the batch of data that was received immediately after the data that was used as the basis for generating the prediction 812.

After the prediction has been generated 812, a change in the data stream may be detected, or predicted 814. The predicted data compressor may then be used to compress 816 one or more batches of data received after the change occurred. Thus, an embodiment of the invention may comprise a predictive component or aspect, and an adaptive component or aspect. To illustrate with the example method 800, a prediction is made, based on historical data stream information and/or data stream patterns, as to which data compressor is likely to be needed for a batch of data received after change has occurred in or to the data stream. When the batch of data is received, the method 800 may adapt to the change by using the predicted data compressor, in place of whatever data compressor was previously in use for the data stream.

As previously stated, embodiments of the invention more specifically relate to detecting a loss, degradation, or decrease in the performance of the prediction model. More specifically, the prediction engine or, more specifically, the prediction model is prone to losing performance over time. This is often caused by changed in properties of the data used as input for the models (e.g., data drift) or by changes in how the outcome of the model should be interpreted (e.g., concept drift). Data drift may relate to new stream patterns that the trained prediction model did not encounter during training. Concept drift may relate to what defines the best compressor for a given stream batch. In both cases, one solution is to retrain the prediction model with new data.

As previously stated, embodiments of the invention may relate to predicting the next best compressor in a sequence of stream batches and using the prediction model. The prediction model is trained on a dataset that captures relationships between sequences of stream patterns and selected compressors under various SLAs. Thus, a sequence of compressors selected for a sequence of stream batches accounts for or encodes the SLA parameters that influenced the decision of the selected compressor.

As a result, it is possible to assume that any drift that manifests at inference time may result in SLA violations. This allows data and concept drifts to be treated similarly. Embodiments of the invention detect these types of drifts efficiently. One way to detect drift is to run, for some stream batches, all compressors available in a pool of compressors, measure compression metrics for each of the compressors, and verify if the prediction model is selecting the best compressor according to the SLA constraint. For example, if the SLA is intended to maximize space savings, it is possible to determine whether the selected compressor is the compressor that yields the highest compression ratio for each stream batch.

This approach, however, is impractical in the context of processing streams due to the computational resources and requirements. Running all compressors on stream batches is computationally expensive and may incur unacceptable performance penalties.

To detect a loss, which may represent by way of example a decrease in performance, a degradation of performance, or a drift, in performance, embodiments of the invention provide a stream batch to both the prediction engine (the prediction model) and to the compressor selector. Because the compressor selector takes SLA constraints as input and the prediction engine was trained with compressors that satisfy various SLA constraints, the compressors inferred by the prediction engine and the compressor selector, Ĉᵢ₊₁ and Ĉⱼ respectively, should be the same. Thus, running both the prediction engine and the compressor selector on the same stream batch should result in the same inference unless drift is present, which is an indication of a loss of performance.

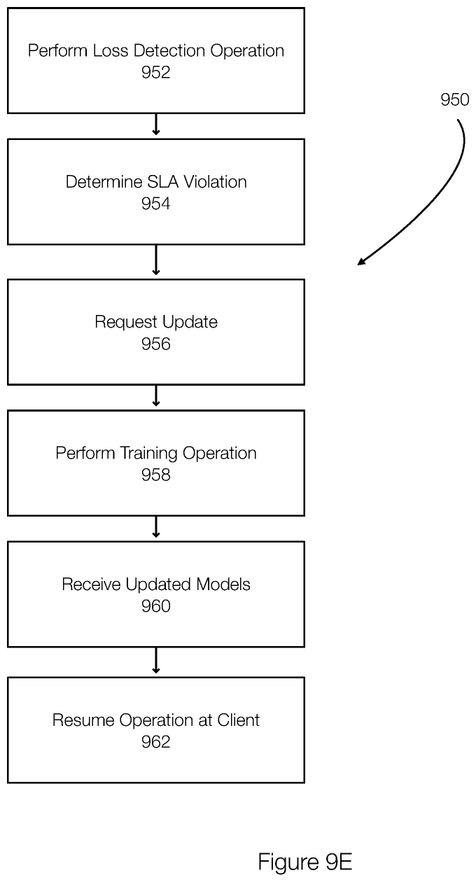

FIG. 9A discloses aspects of addressing the scenario where the prediction engine and more specifically of the prediction model experiences or exhibits a loss in performance. Detecting the loss in performance may be referred to as a loss detection operation. FIG. 9A illustrates a prediction engine 902 that includes a prediction model 906 and a pattern extractor 904. The history 908 represent the past k compressor choices for the past k patterns. This information is used by the prediction model 906 to predict a compressor for the pattern Pᵢ₊₁ (or stream batch 910). The output of the prediction engine 902 or the prediction model 906 is a compressor 912, represented as compressor Ĉᵢ₊₁. The compressor 912 may be used to compress the data or stream batch 910.

At the same time, the stream batch 910 is provided as input to the compressor selector 916. The output 914, which is the compressor Ĉⱼ selected or inferred by the compressor selector 916, is produced. If the compressor 912 selected by the prediction engine 902 and the compressor 914 selected by the compressor selector 916 do not match, a loss in performance may be detected or indicated. The loss in performance may also correspond to an SLA violation or a potential SLA violation.

FIG. 9B discloses aspects of determining or computing SLA violations. FIG. 9B illustrates that the stream batch 910 is input to both the prediction engine 902 and the compressor selector 916, which generate inferences. The inference generated by the prediction engine 902 is the compressor 912 and the inference generated by the compressor selector 916 is the compressor 914.

The compressors 912 and 914 can be evaluated or compared to determine 918 if an SLA violation or a potential SLA violation has occurred. Determining 918 whether an SLA violation is present can be performed in different manners. For example, the evaluation of the compressors 912 and 914 may be performed using a strict mode or a soft mode. The mode may be a variable and can be set to one of the two modes in one embodiment.

In the strict mode, an SLA violation is determined when the compressor 912 and the compressor 914 do not match or are not the same. In one example, different versions of the same compressor do not match in the strict mode. The mode is strict because any differences in the inferred compressors 912 and 914 will indicate a potential SLA violation. This may be true even if the compressors 912 and 914 yield similar results. However, the strict mode may trigger false positives and may result in updates to the prediction model of the prediction engine 902 and/or to the compressor selector 916 when not strictly necessary.

FIG. 9C discloses aspects of a soft mode workflow for determining an SLA violation. The soft mode workflow includes compressing the stream batch 910 with the compressor 912 and with the compressor 914 to obtain, respectively, compression metrics 922 (\hat{m}ᵢ₊₁) and 924 (\hat{m}ⱼ). The violation detector 926 may compare the compression metrics 922 and 924 using, for example, a delta function such as δ(\hat{m}ⱼ, \hat{m}ₓ₊₁). If the delta function is greater than a threshold (∈), an SLA violation or a possible SLA violation is inferred or determined. The soft mode is more computationally expensive than the strict mode as the soft mode requires the inferred compressors to be executed on the stream batch 910. However, allowing the prediction engine 902 to operate using a different compressor than the compressor 914 inferred by the compressor selector 916 may be more practical and may lead to fewer retraining operations. If an SLA violation is determined or flagged, the compressor selector 916 and/or the prediction engine 902 are retrained 920, as illustrated in FIG. 9B.

FIG. 9D discloses aspects of handling performance losses and/or SLA violations. FIG. 9D illustrates, as previously described, that the prediction engine 902 and 914 infer, respectively, compressors 912 and 914 for the stream batch 910. If an SLA Violation is determined 918 (e.g., using a strict mode or a soft mode determination operation), the method determines whether violations exceed 930 a ratio (R). If the ratio is exceeded, the models are updated 932. The ratio may relate or compare a number of inference mismatches (e.g., the inferred compressors are different) to total comparisons. In other words, the loss detection operation may be performed multiple times and the ratio may express the number of times the compressors did not match to the total number of loss detection operations. This may be implemented over n most recent loss detection operations.

In one example, the manner in which an SLA violation is detected in FIGS. 9A-9D (a loss detection operation) may be less effective compared to running all available compressors and selecting the best compressor so satisfy the relevant SLA. However, the performance and computational savings are significant. Using the prediction engine 902 and the compressor selector 916 to detect SLA violations is an effective approach. Both the prediction engine 902 and the compressor selector 916 account for SLAs. The prediction engine 902 accounts for SLA during training and the compressor selector 916 accounts for SLAs during optimization. Thus, if the compressors 912 and 914 are not the same during the loss detection operation, it is possible that at least one of them violates an SLA.

In one embodiment, the prediction engine 902 and the compressor selector 916 are not performed for every stream batch. Rather, the loss detection operation is executed selectively in one embodiment.

In one example, the loss detection operation used both the compressor selector 916 and the prediction model 916 to determine whether there is a loss of performance (in the prediction engine 902 and/or the compressor selector 916) at an interval T. Further, an SLA violation ratio R may also be established to determine whether a computed ratio r of SLA violations flagged by any of the checks is above the ratio R. When the computed ratio r exceeds or is above 930 the ratio R, one or both of the prediction engine 902 and the compressor selector 916 are updated 932. In one example, the model that is experiencing a loss of performance or drift is not identified. Rather, both the prediction engine 902 and the compressor selector 916 are updated 932 in one embodiment.

FIG. 9E discloses aspects of compressing data such as stream batches. The method 950 may operate on a client side that is configured to compress data including stream data. The method 950 may also operate on the server side. As the prediction engine predicts or infers compressors for compressing batches, the loss detection operation may be initiated or performed 952. The loss detection operation may include jointly operating the prediction engine and the compressor selector. If the compressors inferred by the prediction engine and the compressor selector are different (based on a strict or soft mode workflow in one example), an SLA violation is determined 954. Once the SLA violation is determined 954, which may be determined at the client, the client may request an update 956. More specifically, the client may request that the prediction model and the compressor selector be updated in light of the SLA violation or the potential SLA violation.

When the update is requested from the server, the server may access data coming from the client and use the data to retrain 958 the prediction engine and the compressor selector. This allows the server to retrain the prediction engine and the compressor selector using all available data, which includes data that was previously seen and data that was not previously seen by the prediction engine and/or the compressor selector. Once these models are retrained, the updated models are sent to and received 960 by the client (e.g., in a message) or in another manner and the client replaces the existing models with the updated models. This allows the client to resume 962 operation.

Over time the loss detection operation 952 may be performed periodically or at an interval. When the loss detection operation results in determining an SLA violation, the method 950 is performed.

In general, embodiments of the invention may be implemented in connection with systems, software, and components, that individually and/or collectively implement, and/or cause the implementation of, compression operations, loss detection operations, delta operations, model training operations, inference operations, drift detection operations, operations to remedy performance loss, pattern detection operations, or the like.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general, however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

As used herein, the term ‘data’ is intended to be broad in scope. Thus, that term embraces, by way of example and not limitation, data segments such as may be produced by data stream segmentation processes, stream batches, data chunks, data blocks, atomic data, emails, objects of any type, files of any type including media files (video, audio, images), word processing files, spreadsheet files, and database files, as well as contacts, directories, sub-directories, volumes, and any group of one or more of the foregoing. Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: performing compression operations at a client on data using a prediction engine that includes a prediction model, performing a loss detection operation at the client, determining a loss in performance occurs when a compressor inferred by the prediction engine does not match a compressor inferred by a compressor selector, and updating the prediction model and/or the prediction compressor selector.

Embodiment 2. The method of embodiment 1, wherein the data used by the prediction model and the compressor selector comprises streaming data, which includes stream batches.

Embodiment 3. The method of embodiment 1 and/or 2, further comprising determining the loss in performance using a strict mode.

Embodiment 4. The method of embodiment 1, 2, and/or 3, further comprising determining the loss in performance using a soft mode, wherein the soft mode includes: compressing a stream batch with the compressor inferred by the prediction engine and generating first compression metrics, compressing the stream batch with the compressor inferred by the compressor selector and generating second compression metrics, computing a delta function using the first compression metrics and the second compression metrics, wherein the loss in performance is determined when a difference between the first compression metrics and the second compression metrics is greater than a threshold.

Embodiment 5. The method of embodiment 1, 2, 3, and/or 4, wherein the loss in performance is an SLA violation or a potential SLA violation.

Embodiment 6. The method of embodiment 1, 2, 3, 4, and/or 5, further comprising periodically performing the loss detection operation.

Embodiment 7. The method of embodiment 1, 2, 3, 4, 5, and/or 6, further comprising determining the loss in performance when a computed ratio is greater than a predetermined ratio, wherein the ratio compares a number of times the compressor inferred by the compressor selector did not match the compressor inferred by the prediction model during the loss detection operation to n most recent loss detection operations.

Embodiment 8. The method of embodiment 1, 2, 3, 4, 5, 6, and/or 7, further comprising updating the prediction model and the compressor selector at a server using previously acquired data and data that has not been seen by the prediction engine and the compressor selector.

Embodiment 9. The method of embodiment 1, 2, 3, 4, 5, 6, 7, and/or 8, further comprising returning a retrained prediction model and a retrained compressor selector to the client.

Embodiment 10. The method of embodiment 1, 2, 3, 4, 5, 6, 7, 8, and/or 9, further comprising resuming the compression operations with the prediction engine.

Embodiment 11. A system, comprising hardware and/or software, operable to perform any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

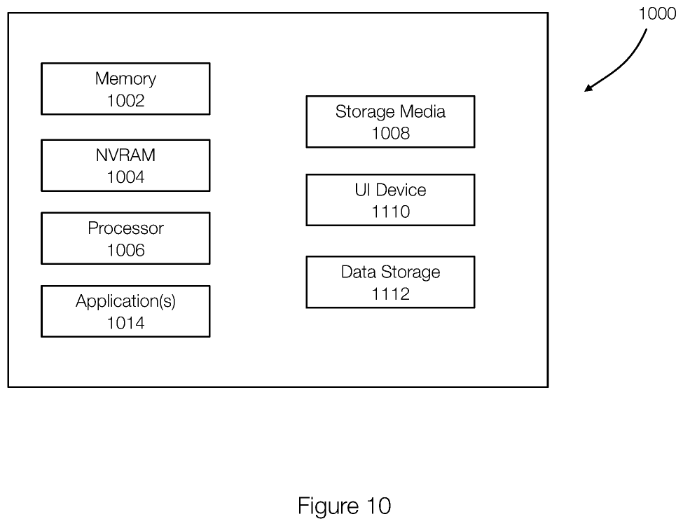

With reference briefly now to FIG. 10, any one or more of the entities disclosed, or implied, by the Figures and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid-state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 1000 may also represent an edge system, a server group, clients and/or servers, a cloud-based system or the like or other computing entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing compression operations at a client on data using a prediction engine that includes a prediction model;
performing a loss detection operation at the client;
determining a loss in performance occurs when a compressor inferred by the prediction engine does not match a compressor inferred by a compressor selector; and
updating the prediction model and/or the prediction compressor selector.

2. The method of claim 1, wherein the data used by the prediction model and the compressor selector comprises streaming data, which includes stream batches.

3. The method of claim 1, further comprising determining the loss in performance using a strict mode.

4. The method of claim 1, further comprising determining the loss in performance using a soft mode, wherein the soft mode includes:
compressing a stream batch with the compressor inferred by the prediction engine and generating first compression metrics;
compressing the stream batch with the compressor inferred by the compressor selector and generating second compression metrics;
computing a delta function using the first compression metrics and the second compression metrics, wherein the loss in performance is determined when a difference between the first compression metrics and the second compression metrics is greater than a threshold.

5. The method of claim 1, wherein the loss in performance is an SLA violation or a potential SLA violation.

6. The method of claim 1, further comprising periodically performing the loss detection operation.

7. The method of claim 1, further comprising determining the loss in performance when a computed ratio is greater than a predetermined ratio, wherein the ratio compares a number of times the compressor inferred by the compressor selector did not match the compressor inferred by the prediction model during the loss detection operation to n most recent loss detection operations.

8. The method of claim 1, further comprising updating the prediction model and the compressor selector at a server using previously acquired data and data that has not been seen by the prediction engine and the compressor selector.

9. The method of claim 8, further comprising returning a retrained prediction model and a retrained compressor selector to the client.

10. The method of claim 9, further comprising resuming the compression operations with the prediction engine.

11. A non-transitory storage medium having stored therein instructions that are executable by one or more hardware processors to perform operations comprising:
performing compression operations at a client on data using a prediction engine that includes a prediction model;
performing a loss detection operation at the client;
determining a loss in performance occurs when a compressor inferred by the prediction engine does not match a compressor inferred by a compressor selector; and
updating the prediction model and/or the prediction compressor selector.

12. The non-transitory storage medium of claim 11, wherein the data used by the prediction model and the compressor selector comprises streaming data, which includes stream batches.

13. The non-transitory storage medium of claim 11, further comprising determining the loss in performance using a strict mode.

14. The non-transitory storage medium of claim 11, further comprising determining the loss in performance using a soft mode, wherein the soft mode includes:
compressing a stream batch with the compressor inferred by the prediction engine and generating first compression metrics;
compressing the stream batch with the compressor inferred by the compressor selector and generating second compression metrics;
computing a delta function using the first compression metrics and the second compression metrics, wherein the loss in performance is determined when a difference between the first compression metrics and the second compression metrics is greater than a threshold.

15. The non-transitory storage medium of claim 11, wherein the loss in performance is an SLA violation or a potential SLA violation.

16. The non-transitory storage medium of claim 11, further comprising periodically performing the loss detection operation.

17. The non-transitory storage medium of claim 11, further comprising determining the loss in performance when a computed ratio is greater than a predetermined ratio, wherein the ratio compares a number of times the compressor inferred by the compressor selector did not match the compressor inferred by the prediction model during the loss detection operation to n most recent loss detection operations.

18. The non-transitory storage medium of claim 11, further comprising updating the prediction model and the compressor selector at a server using previously acquired data and data that has not been seen by the prediction engine and the compressor selector.

19. The non-transitory storage medium of claim 18, further comprising returning a retrained prediction model and a retrained compressor selector to the client.

20. The non-transitory storage medium of claim 19, further comprising resuming the compression operations with the prediction engine.
